(19) United States
(12) Patent Application Publication
(10) Pub. No.: US 2016/0270563 A1
(43) Pub. Date: Sep. 22, 2016

(54) SOLAR POWERED SYSTEMS AND DEVICES FOR IMPROVED SHOPPING CART CORRAL

(71) Applicant: RENEWABLE EDGE LLC, Tarrytown, NY (US)

(72) Inventors: Richard C. CONTRATA, JR., Harrison, NY (US); David J. SCHAFFER, Suffern, NY (US)

(21) Appl. No.: 15/071,076

(22) Filed: Mar. 15, 2016

Related U.S. Application Data
(60) Provisional application No. 62/134,311, filed on Mar. 17, 2015.

(51) Int. Cl. A47F 10/04; F21S 9/03; H02J 7/35; G09F 23/00; H02J 7/00; G09F 13/22; G09F 13/04; G09F 11/295; F21S 8/04; H02J 7/02

(52) U.S. Cl. CPC A47F 10/04; F21S 8/04; F21S 9/037; H02J 7/35; H02J 7/025; H02J 7/0042; G09F 13/22; G09F 13/04; G09F 11/295; G09F 23/00; F21Y 2101/02; F21W 2131/10

(57) ABSTRACT

A solar power system that generates a power supply for features of a shopping cart corral is provided. In particular, a shopping cart corral has a self-contained solar power system for powering, directly by the corral or indirectly by the shopping carts, at least one of a personal device recharging system, lighting system, and advertising system.

### RELATED APPLICATIONS

This application claims the benefit of (priority to U.S. Provisional Application No. 62/134,311 entitled “Solar Powered Systems and Devices for Improved Shopping Cart Corral” filed Mar. 17, 2015, the entire contents of which are hereby incorporated by reference.

### FIELD OF THE INVENTION

The various embodiments relate generally to shopping cart corrals, and more particularly to efficiently powering shopping cart corrals to expand capabilities and potential uses.

### BACKGROUND

Many retail stores provide shopping carts for their customers to allow customers to transport merchandise within the store and to their vehicles. Such stores also commonly provide shopping cart corrals, which may be fixed or portable, in their parking lots or other public spaces for customers to return the shopping carts once they have finished shopping and transported purchased merchandise to their vehicles. Therefore, such shopping cart corrals function as central collection and organization locations for carts in use, potentially preventing damage to vehicles and/or the carts, as well as preventing the disorganized scattering of carts across unoccupied parking spaces. Conventional shopping cart corrals also provide spaces to which the store owner can affix static advertisements (e.g., billboard, posters, panels, etc.)

Therefore, shopping cart corrals may provide some degree of convenience to store owner. However, such convenience may be significantly offset by their costs. For example, housing a shopping cart corral typically requires using viable parking spaces or other open areas, which may be of value to store owners. Further, while some modern shopping cart corrals are configured with additional capabilities such as active advertising or lighting, these capabilities have power requirements that are typically met by the power supply a store building and/or a power supply to other structures located in the parking lot (e.g., light poles, etc.). As a result, these corrals may add to existing power costs as well as requiring installation of permanent structures to house electrical equipment.

### SUMMARY

Systems and devices of the various embodiments provide a shopping cart corral that includes a structure with a roof and a first, second, and third side, in which the structure provides an enclosure area configured to house a plurality of shopping carts. In some embodiments, the shopping cart corral may also include a self-contained solar power system that includes at least one solar panel attached to an outer surface of the roof, and a battery bank coupled to the charge controller. In some embodiments, the charge controller may be provided in an attic space beneath the roof, and the at least one solar panel may be connected to the charge controller via wiring in the attic space. In some embodiments, the solar power system may be configured to provide power to at least one feature of the shopping cart corral.

In some embodiments, the at least one feature of the shopping cart corral may include an LED overhead lamp capable of illuminating the enclosure area. In some embodiments, the at least one feature of the shopping cart corral may include an advertising panel, wherein the advertising panel may be an LED backlit LCD display on at least one of the first, second, and third side of the structure.

In some embodiments, the at least one feature of the shopping cart corral may include an LED backlit sign attached to a portion of the roof exterior. In some embodiments, the at least one feature of the shopping cart corral may include a digital advertising banner configured to display scrolling messages. In some embodiments, the digital advertising banner may be configured to display scrolling messages. In some embodiments, the self-contained solar power system may also include a network interface configured to allow a remote computer system to control messages scrolled on the digital advertising banner. In some embodiments, the at least one solar panel may be an arrangement of at least one flexible solar panel. In some embodiments, the at least one feature of the shopping cart corral may include a charging station configured with at least one of cable ports and induction coils, in which the charging station allows a user to temporarily recharge a portable personal electronic device.

In some embodiments, the shopping car corral may also include at least one power rail configured to supply power to a contact shoe on each of the plurality of shopping carts, and wiring connecting the charge controller to the at least one power rail. In some embodiments, the solar power system is may be configured to also provide power to an auxiliary charging device on each of the plurality of shopping carts while aligned within the enclosure area via the power supplied to the contact shoe.

In some embodiments, the auxiliary charging device may include one or more port capable of receiving a standardized charging cable connected to a user's portable device, and a rechargeable battery unit. In some embodiments, the auxiliary charging device may include an inductive charging portion with a pocket configured to hold a user's portable device that is capable of being inductively recharged, and a rechargeable battery unit. In some embodiments, the shopping cart corral may be resizable and repositionable.

### BRIEF DESCRIPTION OF THE DRAWINGS

The accompanying drawings, which are incorporated herein and constitute part of this specification, illustrate exemplary aspects of the invention. Together with the general description given above and the detailed description given below, the drawings serve to explain features of the invention.

FIGS. 1A and 1B are elevation views of embodiment solar powered shopping cart coral.

FIG. 2A and 2B are elevation views of embodiment flexible solar panels for use in solar powered shopping cart corrals.

FIG. 3A is a side cutaway view of components of the solar power system housed in an attic space of an embodiment solar powered shopping cart corral.

FIG. 3B is a component block diagram of a battery bank in an embodiment solar powered shopping cart corral.

FIG. 4 is an elevation view of an embodiment solar powered shopping cart corral that is recharging an auxiliary charging device on a shopping cart.

FIG. 5 is a component block diagram of an embodiment auxiliary charging device.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “shopping cart corral” is used herein to refer to a receptacle or dedicated structure configured to hold one or more shopping cart in a publically accessible area for a retail location.

The term “solar panel” as used herein means a photovoltaic panel that can be used to convert light into energy.

The various embodiments provide shopping cart corrals that efficiently utilize space and other resources in a manner that minimizes costs to and/or increases revenue for store owners. Such revenue increases may be associated with improved advertising and/or may be based on enhanced customer experiences that are enabled by additional functions provided by embodiment shopping cart corrals.

The various embodiments provide a shopping cart corral configured with an off-grid solar power source that enables efficiently supplying power for active/LED advertisements, overhead lighting, customer convenience features, etc. In particular, the various embodiments provide methods of configuring a shopping cart corral with a solar panel system that powers these features without requiring another power source. The independence of such an off-grid solar power system provided in the various embodiments may allow the corral to be repositioned since its circuitry is not required to be connected to a structure tied-in to the power grid. In some embodiments, store owners may benefit from the relatively low cost of the supplied solar power by creating and displaying more and larger active/LED advertisements. Additionally or alternatively, a store owner may receive a new revenue stream by leasing to one or more third party the improved advertisement space on an embodiment shopping cart corral. With respect to customer convenience, embodiment shopping corrals may further include equipment that allows the shopping carts to be used as stations to which customers may plug in their devices while shopping. In some embodiments, the recharging equipment may be, for example, a docking site configured with one or more port (e.g., USB), and/or one or more induction coil to allow customers to conveniently recharge their portable electronic devices while shopping.

The various embodiments also provide methods of configuring a control system on a shopping cart corral that powers a variety of electronics without requiring an additional power source. In particular, the various embodiments supply power generated from received solar radiation and stored in one or more battery of the shopping cart corral, and include a controller that distributes the power stored in the charged one or more battery to electronic features. In some embodiments, the power distributed to the corral may be transferred to a plurality of shopping carts by charging separate battery units configured on each shopping cart. The separate battery units may be used to supply power to corresponding auxiliary charging devices on each shopping cart, which may be used by customers to charge their personal devices.

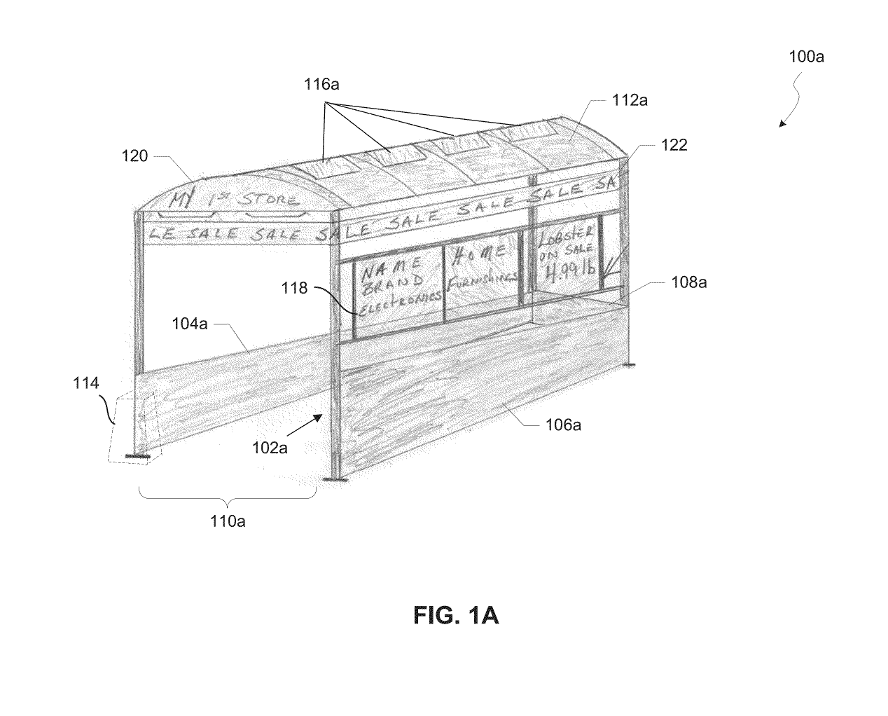

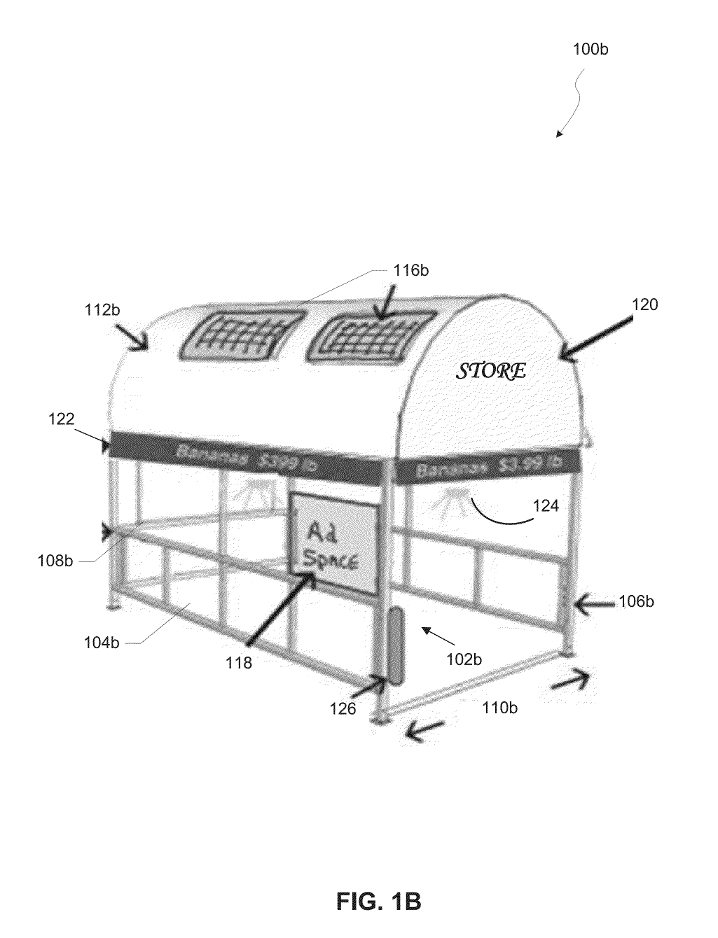

FIGS. 1A and 1B illustrate example shopping cart corrals 100a, 100b that may be configured to power various lighting, advertising, and other systems. In various embodiments, the shopping cart corrals 100a, 100b may include enclosure areas 102a, 102b formed by a first side 104a, 104b, a second side 106a, 106b positioned parallel to the first side 104a, 104b, a third side 108a, 108b that connects and forms corners with the first side 104a, 104b and second side 106a, 106b, respectively.

In various embodiment's, the third side 108a, 108b has a length that is approximately equal to a distance between the first side 104a, 104b and second side 106a, 106b. The shopping cart corral 100a, 100b may also include an opening 110a, 110b opposite the third side 108a, 108b, and having a length approximately equal to the length of the third side. In various embodiments, the first side 1104a, 104b, second side 106a, 106b, and third side 108a, 108b may be positioned such that the length of the opening 110a, 110b is sufficient to accommodate a plurality of shopping carts lined up within the enclosure area 102a, 102b. For example, as shown in FIG. 1B, the width of the opening 110b may be approximately equal to a width of one standard parking space.

In various embodiments, each of the first side 104a, 104b, second side 106a, 106b, and/or third side 108a, 108b may be formed as walls, barriers, and/or other structural components. In some embodiments, any or all of the first side 104a, 104b, the second side 106a, 106b, and the third side 108a, 108b may be formed at least in part using one or metal-containing material (e.g., aluminum, steel, stainless steel, galvanized steel, etc.), plastic (e.g., polystyrene), combination of metal and plastic, wood, carbon fiber and/or other materials that are sufficiently stable to provide support but lightweight to allow for repositioning of the shopping cart corral 100a, 100b. In the various embodiments, the first side 104a, 104b, second side 106a, 106b, and third side 108a, 108b may be bolted, riveted, screwed, nailed, glued or welded together.

In some embodiments, such as shopping cart corral 100a structural components of the first side 104a, second side 106a, and/or third side 108a may be configured with ballasts that temporarily anchor the corral structure, thereby allowing repositioning of the shopping cart corral 100a. An example ballast 114 is shown in FIG. 1A and may form a base using any of a number of heavy materials relative to the materials used in the rest of the corral structure. In some embodiments, such as shopping cart corral 100b, structural components of or attached to the first side 104b, second side 106b, and/or third side 108b may be permanently installed (e.g., using concrete, etc.) thereby providing a fixed corral location.

The shopping cart corral 100a, 1100b may also include a roof 112a, 112b. In various embodiments, the roof 112a, 112b may be a cover constructed from any of a variety of materials over a frame (e.g., aluminum, stainless steel, etc.). The cover may be made using roofing materials that include, but are not limited to, plastics, fabrics, metals (e.g., aluminum, stainless steel, etc.) and/or other materials. In some embodiments, the roof 112a, 112b may be formed by roofing materials attached to aluminum roof support purlins. The shape of the roof 112a, 112b may be based on design and/or functionality requirements. Examples roof shapes may include, but are not limited to, an arch, dome, mono-pitch, multi-pitch, canopy, etc. In some embodiments, the roof 112a, 112b may he shaped to accommodate a particular number, type, arrangement, or angle of solar panels, as well as mounting and storage for the solar power system, discussed in further detail below.

For example, the roof 112b of shopping corral 100b may be attached to roof support purlins, coupled to the first side 104, second side 106, and third side 108, and configured to cover the enclosure area 102. In various embodiments, the shopping cart corral 100a, 100b may be configured with a solar power system, discussed in further detail below, in which solar panels charge one or more batteries (e.g., in a battery bay) that are used as a power source for various electronic systems. various embodiments may include a flexible solar panel arrangement 116a, 116b with one or more flexible solar panel attached to an outside surface of the shopping cart corral 100a, 100b. For example, shopping cart corral 100a may be configured with a flexible solar panel arrangement 116a that has four flexible solar panels positioned in a uniform orientation on the surface of the roof 112a. In another example, shopping cart corral 100b may be configured with a flexible solar panel arrangement 116b that has two flexible solar panels positioned on the surface of the roof 112b, which may he at the same angle or different angles compared to those in flexible solar panel arrangement 1116a. While flexible solar panel arrangements 116a, 116b of corrals 100a, 100b provide solar panels atop the roof 112a, 112b, various other arrangements (not shown) may additionally or alternatively provide flexible solar panels that are positioned on other outer surfaces (e.g., the first side, second side or third side).

In various embodiments, the shopping cart corrals 100a, 100b may be configured with various advertisement spaces, some or all of which may contain displays that receive power from one or more battery of the solar power system (i.e., batteries charged by the panels in the flexible solar panel arrangement 116a, 116b. In some embodiments, shopping cart corrals 100a, 100b may contain backlit advertising panels 118 on one or more of the first side 104a, 104b, second side 106a, 106b, and third side 108a, 108b. Backlighting in the various embodiments may be provided, for example, in the form of an LED-backlit LCD display In some embodiments, one or more advertising panel 118 may be configured to be optionally backlit or unlit, as well as configured to be removable and changeable (i.e., as swappable posters). In some embodiments, one or more advertising panel 118 may include a clear plastic or glass cover over a display area or screen. In some embodiments, one or more advertising panel 118 may be a frame with a clear cover on both the interior and exterior surface to accommodate a two-sided advertisement that is viewable from the both the interior and exterior of the enclosure area 102a, 102b. The one or more advertising panel may allow the capability to provide static slides, scrolling text, live video, and/or animation sequences. Other capabilities that may be provided by the advertising panel include, but are not limited to, interactive features (e.g., via a touch screen or voice commands), and customized advertisement applications that may provide maps and local points of interest to users.

In some embodiments, shopping cart corrals 100a, 1100b may further contain a backlit sign 120 (e.g., with LED lighting) and/or a digital advertising banner 122 with scrolling messages. In various embodiments, the messages of the digital advertising banner 122 may he remotely controlled, for example, via wired or wireless communications. In some embodiments, content for a digital advertising banner may be provided to one or more processing modules in the shopping cart corral 100a, 100b by transmission of a file or file location, such as an internet protocol address, from a remote computer system. In some embodiments, one or more additional digital advertising banner may replace the traditional back-lit displays on the front, back, and/or sides of the first, second, and/or third sides of the shopping cart corral 1100a, 100b

In various embodiment shopping cart corrals, such as shopping cart corral 100b, may be configured with additional features that are powered by the solar power system. For example, with reference to FIG. 1B, shopping cart corral 100b may include overhead interior lighting 124 (e.g., LED lamps, incandescent bulbs, etc.), which may be powered by one or more battery of the solar power system and switched on and off by a charge controller of the solar power system. In another example, shopping cart corral 100b may include a charging station 126 configured with ports and/or induction coils to allow customers to temporarily recharge portable personal electronic devices when in close proximity to the shopping cart corral.

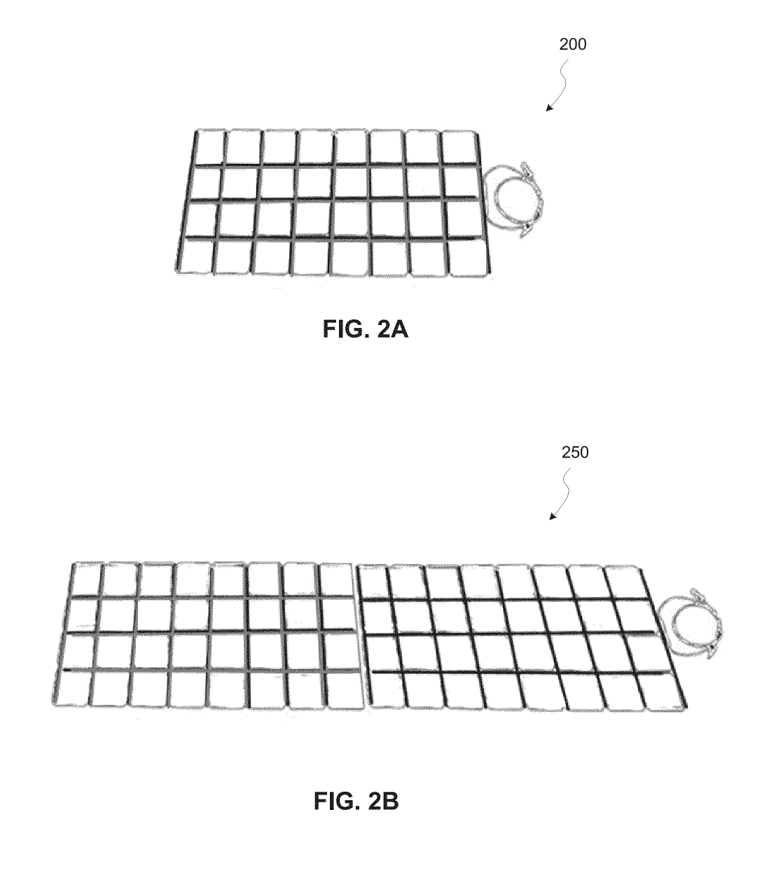

FIG. 2A illustrates a flexible solar panel 200 that is suitable for use in various flexible the solar panel arrangements of embodiment solar powered shopping cart corrals. In an embodiment, a flexible solar panel 200 may be a 100 watt pre-wired, frameless, glass-free solar flex panel that is capable of bending to an arc angle of up to around 30 degrees. In other alternative embodiments, the flexible solar panels may be installed so that they are angled to take advantage of the sun's angle of illumination. In an embodiment, the flexible solar panel 200 may be a frameless panel constructed by laminating monocrystalline or polycrystalline cells onto a thin plastic film. The flexible solar panel may be about 3 mm thick in the various embodiments.

In some embodiments, flexible solar panel arrangements (e.g., arrangements 116a, 116b) may be formed from multiple flexible solar panels 200 that are joined together at the point of installation. FIG. 2B illustrates an example of such arrangement 250 containing two flexible solar panels. Flexible solar panels in a plurality of different sizes may also be made available, for example, for use in a roof surrounding a larger enclosure area. In one embodiment, flexible solar panels 200, 250 may be attached to the top surface of a roof of a shopping cart corral using stainless steel security bolts and strain relief wire connectors.

In another embodiment, flexible solar panels 200, 250 may be attached to the top surface of the roof by drilling security screws through customized grommets on border of panel, thereby avoiding penetrating the panel, which may void a manufacturer's warranty. Due to the bendable characteristic of the flexible solar panels 200, 250, embodiment solar power systems may be configured to fit a variety of different shaped surrounding enclosures. In some embodiments, the flexible solar panels 200, 250 may be covered by or contained in a shell or cover made of thermoplastic (e.g., poly, (methyl methacrylate)).

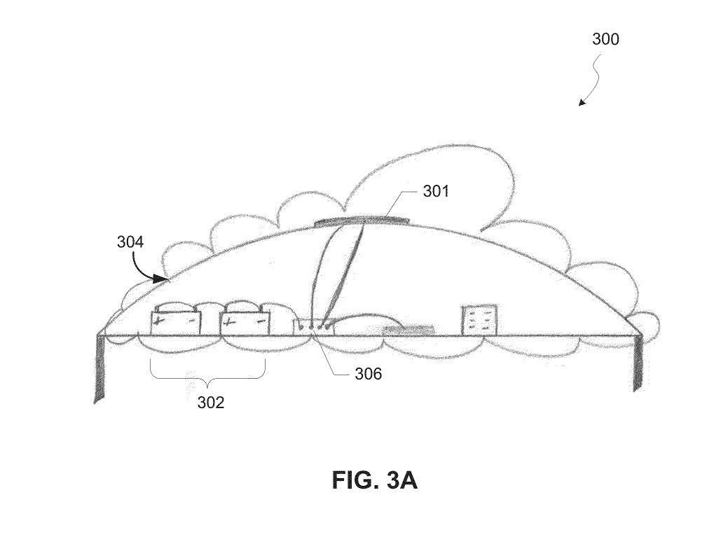

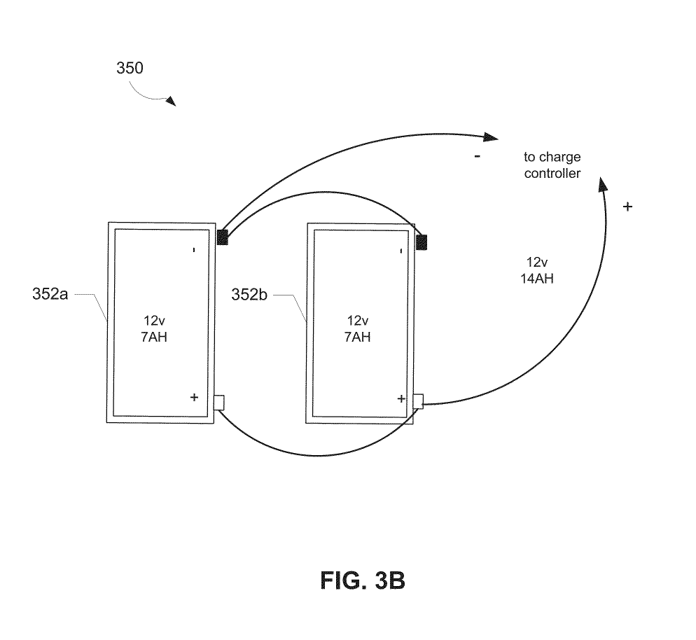

FIG. 3A illustrates an example solar power system 300 for use the various embodiments. In various embodiments, a flexible solar panel arrangement 301 on the surface of a roof of a shopping cart corral may be coupled to a battery bank 302 in an attic space 304 under the roof for charging. The battery charging functions may be regulated by a charge controller 306 also located in the attic space 304. In various embodiments, housing the battery bank 302, charge controller 306, and associated electronics in the attic space 304 may provide protection from theft/vandalism, as well as damage due to the environment.

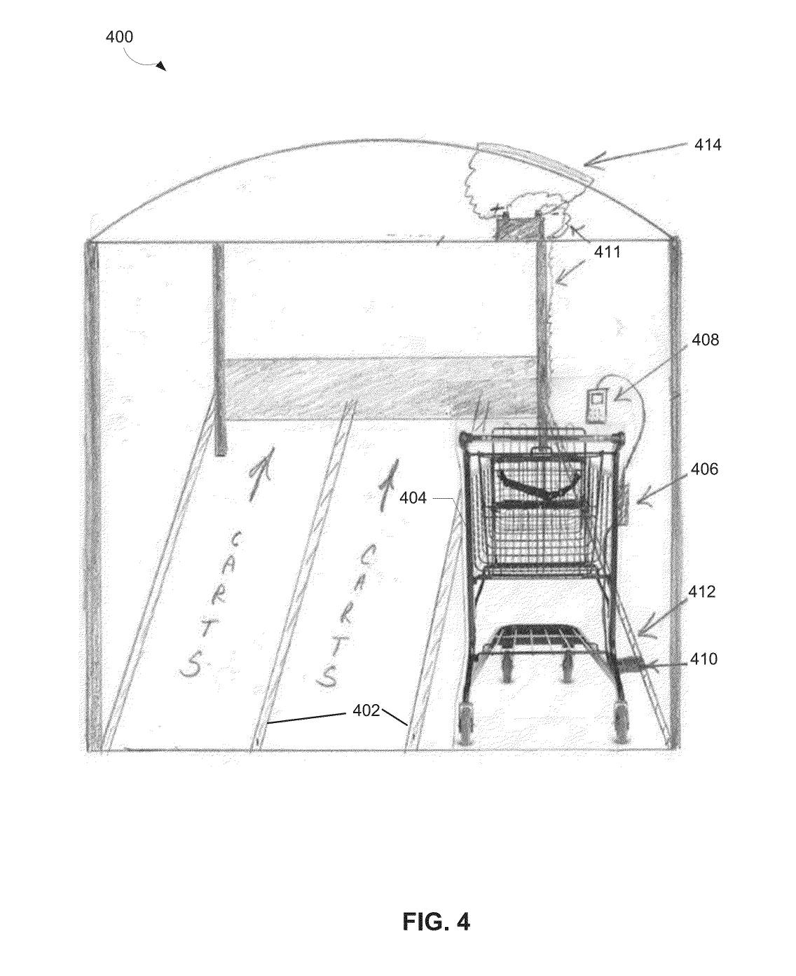

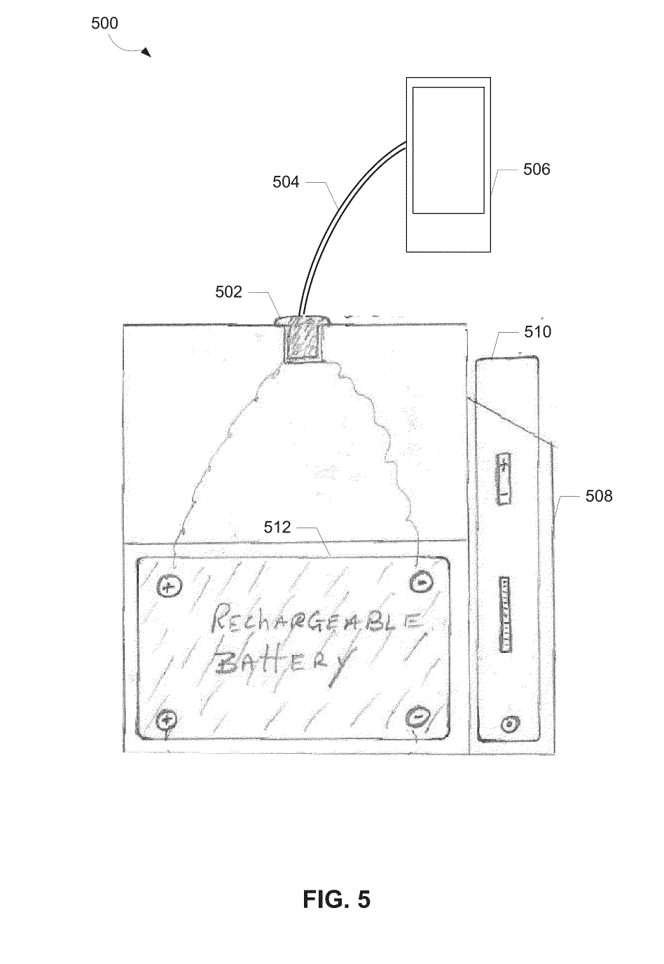

In various embodiments, the power generated from solar panels may be used to charge the batteries in the battery bank 302, which in turn may supply power to the lighting, the advertising, and/or the charging station features of the shopping cart corral through additional wiring (not shown). Further, the battery hank 302, may supply power to auxiliary charging devices on shopping carts, as discussed in further detail below with respect to FIGS. 4 and 5.

In various embodiments, the charge controller 306 may be a maximum power point tracking (MPPT) charge controller capable of managing the output current from the solar panels and input current to the battery bank 302, and of transferring the power to the loads including overhead lighting system, advertising system, and/or charging system (e.g., a charging station, auxiliary charging devices, etc.). In some embodiments, the charge controller 306 may manage the charge rate of the battery bank 302 to prevent over-charging and/or over-discharging of the batteries. In various embodiments, the charge controller 306 may be connected to the flexible solar panels, the battery bank 302, and wiring that leads to the loads via simple positive and negative wire leads.

FIG. 3B illustrates an example battery bank 350, Which may include one or more rechargeable batteries, for use in the embodiment solar powered shopping cart corrals. In some embodiments, the battery bank 350 may have two 12-volt 35-ampere-hour (AH) sealed lead acid (SLA) rechargeable batteries 352a, 352b. The batteries 352a, 352b may be wired in parallel to raise the battery bank 350 from 35 to 70 AH, with the system remaining at 12 volts. The batteries 352a, 352b may be mounted to the attic space with mounting brackets. For example, mounting brackets may be 2×3 inch aluminum pieces, and may be attached into the attic space using any suitable fastener (e.g., nuts and bolts, screws, etc.).

In addition to the charging station that may be provided on a solar powered shopping cart corral, the shopping cart corrals in the various embodiments may be configured to provide charging capabilities for auxiliary charging devices on individual shopping carts. FIG. 4 illustrates an example solar powered shopping cart corral 400 that can accommodate three rows of shopping carts using dividers 402 and the first, second and third sides. While the example shopping cart corral 400 has two dividers, any number of divider may be used to accommodate greater or fewer rows of shopping carts, depending on the corral dimensions (e.g., one divider for two rows of carts, three divider for four rows of carts, etc.). In various embodiments, the shopping carts, represented by shopping cart 404, may be configured with a self-contained auxiliary charging device 406. In some embodiments, the auxiliary charging device 406 may be capable of charging one or more small portable electronic device 408 (e.g., cell phones, tablets, mp3 players, etc.) using power originating from one flexible solar panel 414. For example, the auxiliary charging device may include one or more port capable of receiving a standardized charging cable (e.g., a USB capable). Additionally or alternatively, the auxiliary charging device 406 may include one or more inductive charging portion.

In various embodiments, each shopping cart 404 may be equipped with a contact shoe 410 to receive power for the auxiliary charging device 406 through a charging rail 412. In some embodiments, a charging rail 412 may be provided on one or more of the first side and second side of the shopping cart corral 400. In some, embodiments, charging rail functions may be additionally or alternatively provided on the dividers 402. The charging rail 412 may be connected to power supply circuitry, such as wiring 411, from a controller of the solar power system in the attic space of the shopping cart corral 400. In particular, the wiring 411 may be configured to run along edges/corners of the enclosure area 102a, 102b, or may he encased in a protective material to prevent damage or theft to the circuitry. Further, on the shopping cart 404, wiring may run from the contact shoe 410 to the auxiliary charging device 406 to supply power for recharging a battery of the auxiliary charging device 406. When the shipping cart 404 is placed back into the corral, positioned by the dividers 402, the contact shoe 410 may recharge the auxiliary charging device 406 by contacting the charging rail 412. In this manner, the charging rail 412 may function in a manner similar to a third rail for an electric train.

FIG. 5 illustrates an example auxiliary charging device 500 that may be attached to a shopping cart in various embodiments. In some embodiments, the auxiliary charging device 500 may be configured with a connection port 502 capable of receiving any of a number of conventional connector types. Examples of such connector types may include, but are not limited to, standard-A USB, standard-B USB, micro-USB, Apple Lightning, and/or Portable Digital Media Interface (PDMI). In some embodiment, a customer who is shopping may bring a connector cable 504 of a type supported by the one or more connection port, thereby enabling the customer to recharge a portable electronic device 506 while shopping. In some embodiments, the auxiliary charging device 500 may also be configured with an inductive charging pocket 508 in which a capable portable electronic device 510 may be charged.

The auxiliary charging device 500 may house a battery unit 512 which may be charged through a contact shoe on the shopping cart, as described above with respect to FIG. 4. In some embodiments, the battery unit 512 may include a nickel-cadmium or lithium rechargeable battery. In some embodiments, the battery unit 512 may also include a charge controller to provide battery charge control functions.

The foregoing method descriptions are provided merely as illustrative examples and are not intended to require or imply that the processes of the various embodiments must be performed in the order presented. Skilled artisans may implement the described functionality in varying ways for each particular shopping cart corral, but such implementation decisions should not be interpreted as causing a departure from the scope of the present invention. Words such as “thereafter,” “then,” “next,” etc, are not intended to limit the order of the processes; these words are simply used to guide the reader through the description of the methods. Further, any reference to claim elements in the singular, for example, using the articles “a,” “an” or “the” is not to be construed as limiting the element to the singular.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein, and instead the claims should be accorded the widest scope consistent with the principles and novel features disclosed herein.

What is claimed is:

1. A shopping cart corral, comprising:
a structure comprising a roof and a first, second, and third side, wherein the structure provides an enclosure area configured to house a plurality of shopping ca
a self-contained solar power system, comprising:
at least one solar panel attached to an outer surface of the roof;
a charge controller contained in an attic space beneath the roof wherein the solar panel is connected to the charge controller via wiring in the attic space; and
a battery bank coupled to the charge controller,
wherein the solar power system is configured to provide power to at least one feature of the shopping cart corral.

2. The shopping cart corral of claim 1, wherein the at least one feature of the shopping cart corral comprises an LED overhead lamp capable of illuminating the enclosure area.

3. The shopping cart corral of claim 1, wherein the at least one feature of the shopping cart corral comprises an advertising panel, wherein the advertising panel is an LED backlit LCD display on at least one of the first, second, and third side of the structure.

4. The shopping cart corral of claim 1, wherein the at least one feature of the shopping cart corral comprises an LED backlit sign attached to a portion of the roof exterior.

5. The shopping cart corral of claim 1, wherein the at least one feature of the shopping cart corral comprises a digital advertising banner configured to display scrolling messages.

6. The shopping cart corral of claim 1, wherein the digital advertising banner configured to display scrolling messages a network interface configured to allow a remote computer system to control the advertisement content.

7. The shopping cart corral of claim 6, wherein the self-contained solar power system further comprises a network interface configured to allow a remote computer system to control messages scrolled on the digital advertising banner.

8. The shopping cart corral of claim 1, wherein the at least one solar panel comprises an arrangement of at least one flexible solar panel.

9. The shopping cart corral of claim 1, wherein the at least one feature of the shopping cart corral comprises a charging station configured with at least one of cable ports and induction coils, wherein the charging station allows a user to temporarily recharge a portable personal electronic device.

10. The shopping cart corral of claim 1, further comprising:
at least one power rail configured to supply power to a contact shoe on each of the plurality of shopping carts; and
wiring connecting the charge controller to the at least one power rail,
wherein the solar power system is further configured to provide power to an auxiliary charging device on each of the plurality of shopping carts while aligned within the enclosure area via the power supplied to the contact shoe.

11. The shopping cart corral of claim 1, wherein the auxiliary charging device comprises:
one or more port capable of receiving a standardized charging cable connected to a user's portable device; and
a rechargeable battery unit.

12. The shopping cart corral of claim 1, wherein the auxiliary charging device comprises:
an inductive charging portion comprising a pocket configured to hold a user's portable device that is capable of being inductively recharged; and
a rechargeable battery unit.

13. The shopping cart corral of claim 1, wherein the shopping cart corral is resizable and repositionable.
